(19) United States
(12) Patent Application Publication
(10) Pub. No.: US 2015/0213708 A1
(43) Pub. Date: Jul. 30, 2015

(54) APPARATUS AND METHODS FOR TRACKING IN WIRELESS COMMUNICATION SYSTEMS IN RESPONSE TO AN ACTIVATION EVENT

(71) Applicant: Sony Corporation, Tokyo (JP)

(72) Inventors: Nabaz Barzangi, Lund (SE); Ahmed Tayeh, Lund (SE); Mathias Jensen, Malmo (SE); Mostafa Attariani, Malmo (SE); Rodrigo Terra Rios, Malmo (SE)

(21) Appl. No.: 14/165,858

(22) Filed: Jan. 28, 2014

(51) Int. Cl. G08B 25/01; G08B 25/10; H04W 4/22

(52) U.S. Cl. CPC G08B 25/016; H04W 4/22; G08B 25/10; H04W 88/06

(57) ABSTRACT

A tracking device may transmit a distress message including a tracking device identification to one or more wireless communication device(s) using a wireless communication protocol. Responsive to receiving the distress message, a wireless communication device may transmit a reporting message to an emergency location server. The wireless communication device may transmit information relating to at least one location of the wireless communication device to the emergency location server. The distress message, reporting message, and/or the transmission of information relating to at least one location of the wireless communication device may be automatic, without user input, and/or user notification.

### BACKGROUND

The present disclosure relates to tracking apparatus and methods and, more specifically, to tracking devices, wireless communication devices, servers, systems, and/or methods for tracking in wireless communication systems.

Security is a growing market and is important to many. Tracking devices are available and can be used to determine a location of an object (e.g., a person or item). For example, a small tracking device including a global positioning system (GPS) can be placed in a person's clothes, pet, and/or bike and general packet radio service (GPRS) transmissions can be used to report and/or track the location of the person, pet, and/or bike. However, if the device is thrown away or even destroyed, then only the last known location before it was thrown away or destroyed may be available. This can make tracking the object and/or perpetrator difficult without further information. Thus, typical tracking devices may only be useful as long as the tracking device is with the object and in working condition.

### SUMMARY

Some embodiments of the disclosure provide methods of operating a wireless tracking device. Information relating to a location of the tracking device may be determined and the information relating to the location of the tracking device may be transmitted to a monitoring device using a first wireless communication protocol. Responsive to detecting an activation event, a distress message may be transmitted to at least one wireless communication device using a second wireless communication protocol different than the first wireless communication protocol. The distress message may comprise an identification of the wireless tracking device.

Further embodiments provide tracking devices configured to perform such methods.

Further embodiments of the disclosure are directed to methods of operating a wireless communication device. A distress message may be received from a wireless tracking device. The distress message may include an identification of the wireless tracking device. Responsive to receiving the distress message, a reporting message may be transmitted to an emergency location server. The reporting message may include the identification of the wireless tracking device and an identification of the wireless communication device.

Further embodiments provide wireless communication devices configured to perform such methods.

Additional embodiments of the disclosure are directed to methods of operating an emergency location server. A first reporting message may be received from a first wireless communication device. The reporting message may include an identification of the first wireless communication device and an identification of a first tracking device. Responsive to an emergency command relating to the first tracking device, a location command may be transmitted to the first wireless communication device and information relating to a location of the first wireless communication device may be received. In some embodiments, a second reporting message may be received from a second wireless communication device. The second reporting message may include an identification of the second wireless communication device and an identification of a second tracking device. Responsive to a predetermined period of time passing after receiving the second reporting message without receiving an emergency command relating to the second tracking device, the information relating to the second tracking device may be removed from memory at the emergency location server.

Further embodiments provide systems and/or servers configured to perform such methods.

Other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims.

### BRIEF DESCRIPTION OF THE DRAWINGS

Features of examples of embodiments will be more readily understood from the following detailed description of specific embodiments thereof when read in conjunction with the accompanying drawings, in which:

FIG. 1 is a schematic diagram illustrating a wireless communications system according to some embodiments;

FIG. 2 is a block diagram illustrating a wireless tracking device according to some embodiments;

FIG. 3 is a block diagram illustrating a wireless communication device according to some embodiments;

FIG. 4 is a block diagram illustrating a monitoring device according to some embodiments;

FIG. 5 is a block diagram illustrating an emergency location server according to some embodiments;

FIG. 6 is a flowchart illustrating operations of a tracking device according to some embodiments;

FIG. 7 is a flowchart illustrating operations of a wireless communication device according to some embodiments;

FIG. 8 is a flowchart illustrating operations of an emergency location server according to some embodiments; and

FIG. 9 is a flowchart illustrating additional operations of an emergency location server according to some embodiments.

### DETAILED DESCRIPTION

Embodiments of the present disclosure will be described more fully hereinafter with reference to the accompanying drawings. Other embodiments may take many different forms and should not be construed as limited to the embodiments set forth herein. Like numbers refer to like elements throughout.

While embodiments of inventive concepts may be susceptible to various modifications and alternative forms, specific embodiments thereof are shown by way of example in the drawings and will herein be described in detail. It should be understood, however, that there is no intent to limit embodiments of inventive concepts to the particular forms disclosed, but on the contrary, the present disclosure is to cover all modifications, equivalents, and alternatives falling within the spirit and scope of the inventive concepts as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will be understood that, although the terms “first,” “second,” etc. may be used herein to describe various elements, these elements should not be limited by these terms. These terms are only used to distinguish one element from another. Thus, a first element could be termed a second element without departing from the teachings of the present embodiments

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

It is to be understood that the functions/acts indicated in the illustrated blocks may occur out of the order noted in the operational illustrations. For example, two blocks shown in succession may in fact be executed substantially concurrently or the blocks may sometimes be executed in the reverse order, depending upon the functionality/acts involved.

The inventive subject matter may be embodied as methods, electronic devices, and/or computer program products. Accordingly, the inventive subject matter may be embodied in hardware and/or in software (including firmware, resident software, micro-code, etc.). Furthermore, the inventive subject matter may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain or store the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Various embodiments of the present disclosure provide methods of tracking, particularly after an activation event has occurred. In some embodiments, an expanded system and/or method for tracking may be provided when an activation event has occurred with respect to a particular tracking device. An expanded and/or improved system and/or method for tracking may be provided by allowing for and/or configuring additional devices to be tracked. This may allow for and/or extend the capability to locate the object being tracked with the particular tracking device.

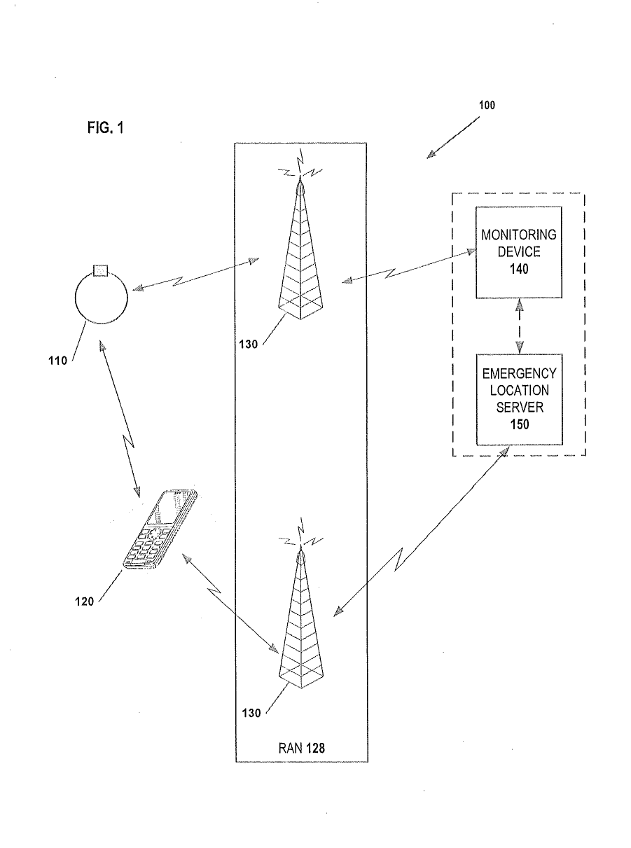

FIG. 1 illustrates an example wireless communication system 100, which may support radio telephone communications, packet switched data service (e.g., GPRS), etc., and the system 100 may support tracking of one or more tracking device(s) 110 and/or wireless communication device(s) 120. As used herein, “tracking device” refers to any device that is configured to transmit information relating to at least one location of the device. Exemplary tracking devices 110 may include, but are not limited to, mobile telephones, pagers, dedicated tracking devices, wearables, accessories, and/or any combination thereof. A tracking device 110 may take any form. For example, a tracking device 110 may be embodied as an accessory, such as, but not limited to, a bracelet, ring, watch, necklace, earring, buckle, belt, pin, hair clip, and/or the like and/or may be hidden and/or enclosed in an item, such as, but not limited to, an item of apparel, bag, purse, pen, phone, accessory, and/or the like. In some embodiments, a tracking device 110 may be a wearable tracking device.

For purposes of illustration and explanation only, these and other embodiments of present inventive concepts are described herein in the context of operating in a Radio Access Network (RAN) 128 that communicates over radio communication channels with wireless communication devices 120 (also referred to as wireless terminals) using a plurality of base stations 130. Radio Access Network 128 of FIG. 1, for example, may provide wireless communications according to one or more of the following wireless communications protocols, Advanced Mobile Phone Service (AMPS), ANSI-136, Global System for Mobile Communications (GSM), Third Generation Partnership Project (3GPP) Long Term Evolution (LTE), General Packet Radio Service (GPRS), enhanced data rates for GSM evolution (EDGE), Digital Communications Services (DCS), Personal Digital Cellular (PDC), Personal Communications Services (PCS), Code Division Multiple Access (CDMA), wideband-CDMA, CDMA2000, and/or Universal Mobile Telecommunications System (UMTS) frequency bands. Other bands can also be used in embodiments according to the inventive concepts. Also, various embodiments may be compatible with Long Term Evolution (LTE) and/or High Speed Packet Access (HSPA) standards. It will be understood, however, that present inventive concepts are not limited to such embodiments and may be embodied generally in any type of communication network.

As used herein, a wireless communication device 120 can include any device that communicates with (e.g., transmits and/or receives communications to/from) a communication network (e.g., RAN 128), and may include, but is not limited to, a mobile telephone (“cellular” telephone), laptop/portable computer, pocket computer, hand-held computer, desktop computer, a machine to machine (M2M) or MTC type device, a sensor with a wireless communication interface, etc.

In communicating with the RAN 128, the tracking device 110 may transmit information relating to at least one location of the tracking device 110 to a monitoring device 140, which may store such information. Communications with the RAN 128 may allow for the wireless tracking device 120 to transmit information to an emergency location server 150, which may store such information and may be part of the monitoring device 140.

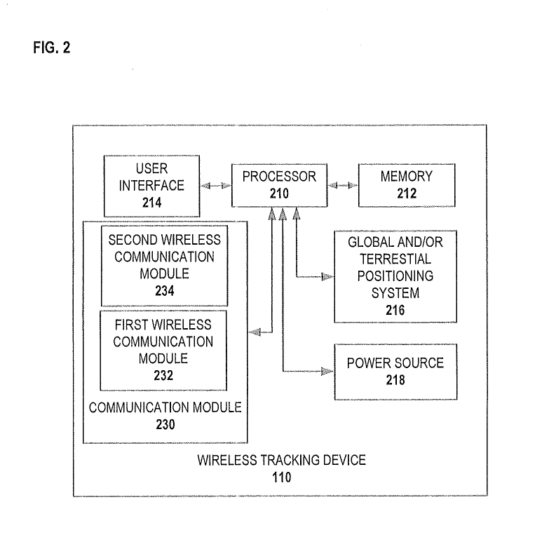

Referring now to FIG. 2, a block diagram is provided illustrating a tracking device 110, according to various embodiments of the present inventive concepts. The tracking device 110 may include a memory 212, a user interface 214, a global and/or terrestrial positioning system 216, a power source 218, a communication module 230, and a processor 210. The processor 210 may include any microprocessor and/or microcontroller used for tracking device applications. The processor 210 may include a signal processor. Additionally, or alternatively, a signal processor may be provided as a separate component of the tracking device 210.

The communication module 230 may be operatively coupled to the processor 210 and may operate under the control of the processor 210. The communication module 230 may include a first wireless communication module 232 and a second wireless communication module 234. The first and second wireless communication modules 232, 234 may be separate components and/or the first and second wireless communication modules 232, 234 may share one or more components. Alternatively, the first and second wireless communication modules 232, 234 may be a single module that provides the functionality for both wireless communication modules. In some embodiments, the first wireless communication module 232 provides communication according to a long range communication protocol, such as, but not limited to a cellular communication protocol, and the second wireless communication modules 234 provides communication according to a short range communication protocol, such as, but not limited to, a non-cellular communication protocol (e.g., Wifi, Bluetooth, etc.).

The first communication module 232 may include transmitter and/or receiver circuits, which may cooperate to transmit and/or receive wireless communication signals. According to various embodiments, the first communication module 232 of the tracking device 110 may be configured to operate in any of the following bands: Advanced Mobile Phone Service (AMPS), ANSI-136, Global System for Mobile Communications (GSM), Third Generation Partnership Project (3GPP) Long Term Evolution (LTE), General Packet Radio Service (GPRS), enhanced data rates for GSM evolution (EDGE), Digital Communications Services (DCS), Personal Digital Cellular (PDC), Personal Communications Services (PCS), Code Division Multiple Access (CDMA), wideband-CDMA, CDMA2000, and/or Universal Mobile Telecommunications System (UMTS) frequency bands. Other bands can also be used in embodiments according to the inventive concepts. Also, various embodiments may be compatible with Long Term Evolution (LTE) and/or High Speed Packet Access (HSPA) standards.

The second communication module 234 may include transmitter and/or receive circuits, which may cooperate to transmit and/or receive wireless communication signals according to a short range communication protocol, such as, for example, Wifi, Bluetooth, etc.

Additionally or alternatively, in some embodiments, the tracking device 110 may be configured to use Global Positioning System (GPS), terrestrial positioning, and/or Wireless Local Area Network (WLAN) frequency bands to determine a position thereof.

Each tracking device 110 may have a unique identification (ID), such as, but not limited to, an identification number or code associated with the particular tracking device 110, an international mobile equipment identity (IMEI) unique to the tracking device 110, a caller identification (e.g., telephone number) associated with a particular subscription and/or tracking device 110, and/or a net address, such as a wife net address unique to the tracking device 110.

Referring to FIGS. 1 and 2, the tracking device 110 may determine information relating to at least one location of the tracking device 110. The global and/or terrestrial positioning system 216 of the tracking device 110 may be configured to determine information relating to at least one location of the tracking device in response to Global Positioning System (GPS) signals received from at least one global positioning satellite and/or by using positioning signals received from a terrestrial positioning system. According to some embodiments, processor 210 may measure positioning signals received through positioning system 216, determine a position based on these measurements, and transmit the position through first wireless communication module 232 and RAN 128 to monitoring device 140. According to some other embodiments, processor 210 may measure the positioning signals received through positioning system 216 and transmit measurement results through first communication module 232 and RAN 128 to monitoring device 140, and monitoring device 140 may determine a position of the tracking device 110 based on the measurement results.

The tracking device 110 may transmit the information relating to at least one location to a monitoring device 140. The location information associated with the tracking device 110 may be transmitted to the monitoring device 140 in real-time or at a predetermined time intervals, such as, but not limited to, every 1 minute, 5 minutes, 10 minutes, 30 minutes, 1 hour, etc. Thus, in some embodiments, location information relating to the tracking device 110 may be accessible to a user (i.e., an individual utilizing the tracking device 110), someone associated with a user, and/or an agent (e.g., a government agent or agent associated with the monitoring device) through the monitoring device 140.

The location information relating to at least one location of the tracking device 110 may be transmitted to a monitoring device 140 using a wireless communication protocol. The first wireless communication module 232 may be configured to transmit the information relating to at least one location of the tracking device 110 through RAN 128 using a long range communication protocol to transmit the location information to the monitoring device 140. In some embodiments, the first wireless communication module 232 may transmit information relating to a location of the tracking device 110 using a cellular communication protocol. Thus, the tracking device 110 may communicate with the monitoring device 140 via a base station 130 of RAN 128.

The monitoring device 140 may include a monitoring server and/or a cloud computing system. Cloud computing systems may include servers, network storage devices, routers, gateways, communication links, and/or other devices.

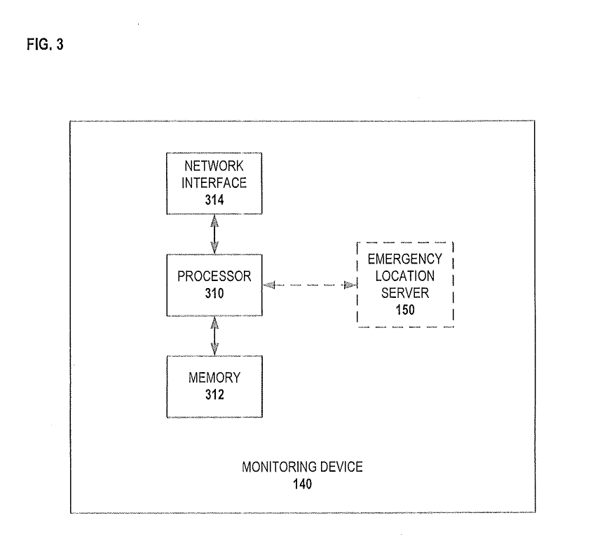

Referring to FIG. 3, a block diagram is provided illustrating a monitoring device 140, according to various embodiments of the present inventive concepts. The monitoring device 140 may include a processor 310, a memory 312, and a network interface 314. The location information from the tracking device 110 may be saved and/or stored in the memory 312 of the monitoring device 140 for a predetermined period of time and/or may be accessible to a user. A user, someone associated with a user, and/or an agent may access the location information relating to the tracking device 110 through the use of a Web browser. In some embodiments, the network interface 314 is configured to allow a user to access the location information relating to the tracking device 110. Authorization may be required in order to access the location information relating to the tracking device 110. Thus, the monitoring device 140 may require a key or code to be entered before the location information relating to the tracking device 110 is accessible.

In some embodiments, the monitoring device 140 may include an emergency location server 150 as a component of the monitoring device 140. Alternatively, the emergency location server 150 and the monitoring device 140 may be two separate components or the emergency location server 150 and the monitoring device 140 may share one or more components.

A tracking device 110 may detect an activation event. “Activation event”, as used herein, refers to an action that has been characterized as signaling that the object using the tracking device 110 may be in distress (e.g., in an emergency situation and/or in need of assistance). Exemplary activation events include, but are not limited to, improper removal or handling of the tracking device 110, entry of a distress code into the tracking device 110, disabling or destroying one or more parts of the tracking device 110 (e.g., disabling communication with the monitoring device 140), a change in pattern in the use or removal of the tracking device 110, separation from a component of or associated with the tracking device 110, entering a location identified as outside the “safe” locations for the tracking device 110, and/or remaining in a stationary location for a prolonged predetermined time period. Thus, in some embodiments, a user may initiate an activation event or transmit an activation event message to the tracking device 110.

Referring to FIGS. 1 and 2, responsive to detecting an activation event, the tracking device 110 may transmit a distress message to at least one wireless communication device 120 using a wireless communication protocol. The distress message may be transmitted automatically in response to the activation event without user input. In some embodiments, the second communication module 234 may be configured to transmit the distress message to one or more wireless communication devices 120.

The distress message may be transmitted by the second communication module 232 using a short range communication protocol. In some embodiments, the distress message may be transmitted via a non-cellular communication protocol. Exemplary non-cellular communication protocols include, but are not limited to, WiFi, Bluetooth, WiMax, ZigBee, near field communication (NFC), infrared, and/or Ultra Wide Band (UWB).

The distress message may include the tracking device ID and/or may include information relating to at least one location of the tracking device 110 (e.g., the last known location of the tracking device 110). In some embodiments, the distress message may be encrypted and/or may be encrypted after it is received by the at least one wireless communication device 120.

As used herein, a “wireless communication device” may include a cellular radiotelephone and/or smart phone with or without a multi-line or other display; a Personal Communications System (PCS) terminal that may combine a cellular radiotelephone with data processing, facsimile and data communications capabilities; a Personal Digital Assistant (PDA) that can include a radiotelephone, pager, Internet/intranet access, Web browser, organizer, calendar, and/or a global positioning system (GPS) receiver; a mobile terminal (e.g., a mobile telephone); a portable audio player; a portable video player; a camera; an electronic reading device; a portable computer (e.g., a tablet computer, a netbook computer, or a laptop computer); and/or other device that includes a radiotelephone transceiver. Wireless communication devices 120 may also be referred to as “pervasive computing” devices.

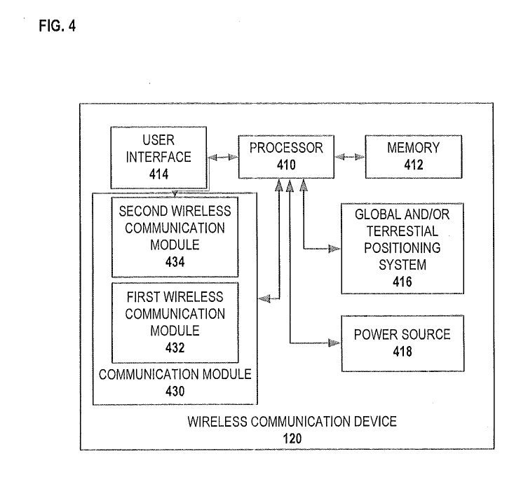

Referring now to FIG. 4, a block diagram is provided illustrating a wireless communication device 120, according to various embodiments of the present inventive concepts. The wireless communication device 120 may include a memory 412, a user interface 414, a global and/or terrestrial positioning system 416, a power source 418, a communication module 430, and a processor 410. The processor 410 may include any microprocessor and/or microcontroller used for wireless communication device applications. The processor 410 may include a signal processor. Additionally, or alternatively, a signal processor may be provided as a separate component of the tracking device 110.

The communication module 430 may be operatively coupled to the processor 410 and may operate under the control of the processor 410. The communication module 430 may include a first wireless communication module 432 and a second wireless communication module 434. The first and second wireless communication modules 432, 434 may be separate components and/or the first and second wireless communication modules 432, 434 may share one or more components. Alternatively, the first and second wireless communication modules 432, 434 may be a single module that provides the functionality for both wireless communication modules. In some embodiments, the first wireless communication module 432 provides communication according to a long range communication protocol, such as, but not limited to a cellular communication protocol, and the second wireless communication module 434 provides communication according to a short range communication protocol, such as, but not limited to, a non-cellular communication protocol (e.g., Wifi, Bluetooth, etc.).

The first communication module 432 may include a transmitter and/or receiver circuits, which may cooperate to transmit and receive signals, such as wireless communication signals. According to various embodiments, the first communication module 432 of the wireless communication device 120 may be configured to operate in any of the following bands: Advanced Mobile Phone Service (AMPS), ANSI-136, Global System for Mobile Communications (GSM), Third Generation Partnership Project (3GPP) Long Term Evolution (LTE), General Packet Radio Service (GPRS), enhanced data rates for GSM evolution (EDGE), Digital Communications Services (DCS), Personal Digital Cellular (PDC), Personal Communications Services (PCS), Code Division Multiple Access (CDMA), wideband-CDMA, CDMA2000, and/or Universal Mobile Telecommunications System (UMTS) frequency bands. Other bands can also be used in embodiments according to the inventive concepts. Also, various embodiments may be compatible with Long Term Evolution (LTE) and/or High Speed Packet Access (HSPA) standards.

The second communication module 434 may include transmitter and/or receive circuits, which may cooperate to transmit and/or receive wireless communication signals according to a short range communication protocol, such as, for example, Wifi, Bluetooth, etc.

Additionally or alternatively, in some embodiments, the wireless communication device 120 may be configured to use Global Positioning System (GPS), terrestrial positioning, and/or Wireless Local Area Network (WLAN) frequency bands to determine a position thereof.

Referring to FIGS. 1 and 3, the distress message may be received by one or more wireless communication devices 120 that are in range of the tracking device 110. In some embodiments, the second communication module 434 of the wireless communication device 120 may be configured to receive the distress message. The distress message may include an ID of the tracking device 110.

Responsive to receiving the distress message, the one or more wireless communication devices 120 may each separately transmit a reporting message to an emergency location server 150 using a wireless communication protocol. The reporting message may include the ID of the tracking device 110 and an ID of the wireless communication device 120.

The wireless communication protocol used by the wireless communication device 120 may utilize the wireless communication module 430 of the wireless communication device 120. In some embodiments, the first communication module 432 may be configured to transmit the information relating to at least one location of the wireless communication device 120 through RAN 128 using a long range communication protocol to transmit the location information to the emergency location server 150. In some embodiments, the first wireless communication module 432 may transmit location information of the wireless communication device 120 using a cellular communications protocol through RAN 128 including one or more base stations 130. Thus, the wireless communication device 120 may communicate with the emergency location server 150 via a base station 130. The tracking device 110 and the wireless communication device 120 may communicate using the same or different base stations of the same or different RAN 128 service providers.

Thus, in some embodiments, a wireless communication device 120 may be high jacked in order to transmit the reporting message to the emergency location server 150 and/or to transmit information relating to at least one location of the wireless communication device 120.

The reporting message sent by the one or more wireless communication devices 120 may include an ID of the tracking device 110 and/or an ID of the wireless communication device 120, such as, but not limited to, an identification number or code associated with the particular device 120, an international mobile equipment identity (IMEI) unique to the device 120, a caller identification (e.g., telephone number) associated with a particular subscription and/or device 120, and/or a net address, such as a wifi net address unique to the device 120.

In some embodiments, the reporting message may initiate a public warning message. The public warning message may be transmitted over a predetermined and/or specialized radio band, such as, but not limited to, a public warning system. This may allow for a government authority, upon receiving the tracking device 110 ID and/or one or more wireless communication device 120 IDs, to confirm the distress message and/or reporting message (i.e., that there is a situation requiring assistance associated with the tracking device 110 that transmitted the distress message). The government authority may process the distress message and/or reporting message as an alert to take action and/or investigate and/or the government authority may initiate and/or transmit a public warning message. In some embodiments, the public warning message may be transmitted to the public using radio, television, e-mail, cellular communications (e.g., cell phone text message), and/or digital displays (e.g., highway signs) and may identify the user of the tracking device 110.

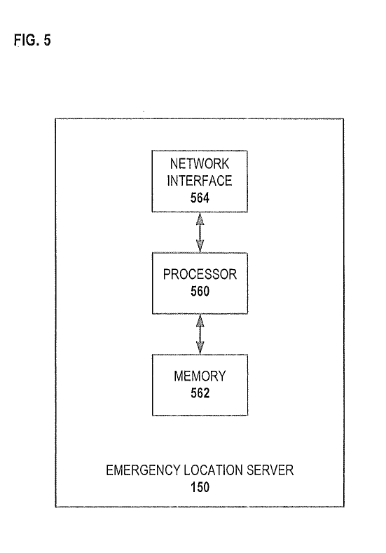

FIG. 5 is a block diagram illustrating an emergency location server 150, according to various embodiments of the present inventive concepts. The emergency location server 150 may include a processor 560, a memory 562, and a network interface 564. The reporting message from the wireless communication device 120 may be saved and/or stored in the memory 562 of the emergency location server 150 for a predetermined period of time.

The information stored in memory 562 of the emergency location server 150 may be accessible to a user, someone associated with a user, and/or an agent (e.g., a government authority such as, for example, a police officer).

In some embodiments, only a government authority may be able to access the information stored in the memory 562 of the emergency location server 150. For the government authority to access the emergency location server 150, a key or code (e.g., username and/or password) may be required. The government authority may access the emergency location server 150 to obtain information relating to at least one location of one or more wireless communication device(s) 120 and/or may request such information, such as, for example, by having the emergency location server 150 transmit a location command to the one or more wireless communication device(s) 120. Alternatively, the government authority may be notified that there is no emergency associated with the tracking device 110 that transmitted the distress message and may have the emergency location server 150 transmit a no emergency command to the one or more wireless communication device(s) 120.

The government authority may only be able to access the information in response to confirmation of the distress message (i.e., there is a situation requiring assistance associated with the tracking device 110 that transmitted the distress message), for example, if a user of the tracking device is reported missing. Upon confirming the distress message, the government authority may then transmit an emergency command to the emergency location server 150. This may allow the government authority to access location information relating to a wireless communication device 120 that transmitted a reporting message to the emergency location server 150. Alternatively, the government authority may transmit a no emergency command to the emergency location server 150. A no emergency command may be sent if there is no emergency and/or situation requiring assistance associated with the tracking device 110 that transmitted the distress message. In certain embodiments, the emergency location server 150 may be part of a government system and/or under the control of a government authority and/or a government agency.

In some embodiments, a user associated with the tracking device and/or someone associated with a user may be able to access the emergency location server 150. The user and/or individual associated with the user may determine if a distress message was sent by the tracking device 110 and/or if a reporting message was sent by one or more wireless tracking devices 120. The user and/or individual associated with the user may be able to transmit an emergency command or a no emergency command to the emergency location server 150.

In some embodiments, a user and/or someone associated with a user may not be able to access the location information from one or more wireless communication devices 120 stored in the memory 562 of the emergency location server 150, but may be able to transmit an emergency command or a no emergency command to the emergency location server 150.

An emergency command may signal to the emergency location server 150 to transmit a location command to the one or more wireless communication devices 120. The location command may instruct the one or more wireless communication devices 120 to transmit information relating to at least one location of the one or more wireless communication devices 120.

A no emergency command may signal to the emergency location server 150 to disconnect from one or more wireless communication devices 120 and/or to delete information stored on memory 562 of the emergency location server 150 relating to the one or more wireless communication devices 120.

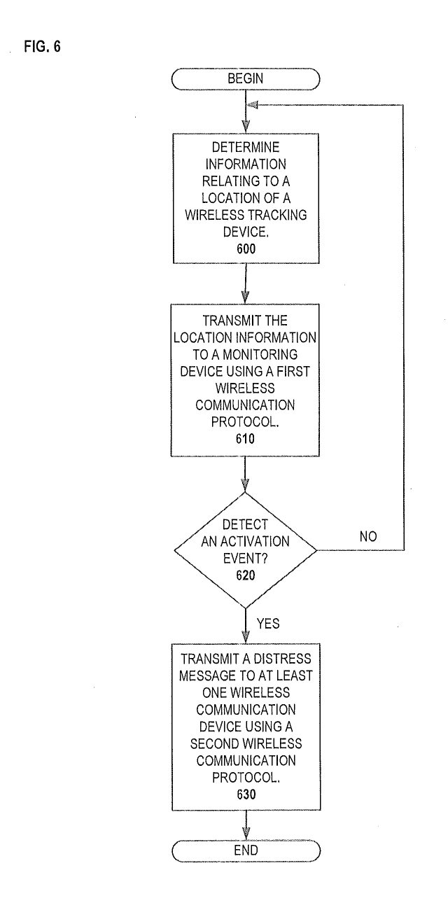

FIG. 6 illustrates a flowchart for a tracking device 110 according to some embodiments. The tracking device 110 may determine information relating to a location of tracking device at block 600. The location information associated with the tracking device may be transmitted in real-time or at a predetermined time intervals at blocks 610 and 620 until an activation event is detected at block 620. Determining information relating to a location of tracking device at block 600 may be responsive to Global Positioning System (GPS) signals received from at least one global positioning satellite and/or using positioning signals received from a terrestrial positioning system.

The location information associated with the tracking device may be transmitted to a monitoring device at block 610 using a first wireless communication protocol. The monitoring device 140 may comprise a monitoring server. In some embodiments, the first wireless communication protocol is a long range and/or cellular communication protocol.

At any time, a tracking device may detect occurrence of an activation event at block 620. In some embodiments, the tracking device may detect an activation event. If no activation even has occurred, then the tracking device may continue to determine location information and transmit the location information to the monitoring device. If an activation event has been detected, then the tracking device may transmit a distress message to at least one wireless communication device 120 using a second wireless communication protocol at block 630. The second wireless communication protocol may be different than the first wireless communication protocol. In some embodiments, the second wireless communication protocol is a short range and/or non-cellular communication protocol (e.g., Wifi, Bluetooth, etc.). According to some embodiments, the distress message is transmitted at block 630 automatically without user input in response to detection of an activation event at block 620, e.g., responsive to improper removal of the tracking device, tampering with the tracking device, responsive to user entry of a distress code, etc.

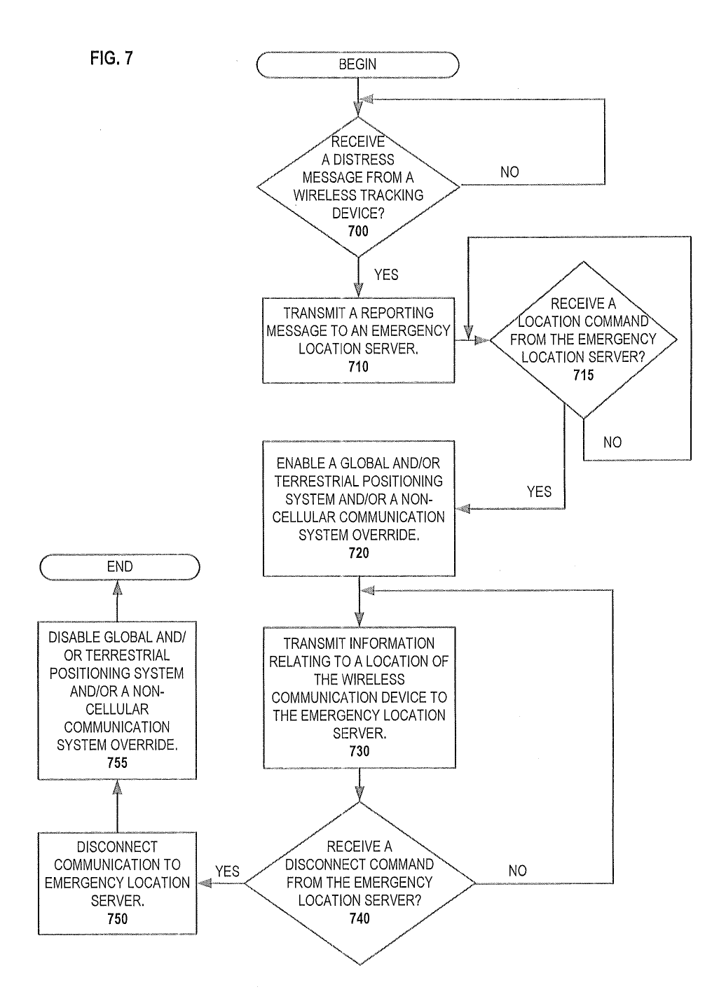

FIG. 7 illustrates a flowchart for a wireless communication device 120 according to some embodiments. A wireless communication device 120, at any time, may determine if a distress message has been received from a tracking device at block 700. The distress message may include an ID of the wireless tracking device. The distress message may be received by the wireless communication device at block 700 using a short range and/or non-cellular communication protocol (e.g., Wifi, Bluetooth, etc.). According to some embodiments, the distress message may be received by the wireless communication device at block 700 automatically without the wireless communication device user's input and/or without notifying the wireless communication device user.

If no distress message has been received, then no action is needed on behalf of the wireless communication device in regard to a tracking device. If a distress message has been received at block 700, then the wireless communication device may transmit a reporting message to an emergency location server at block 710. The reporting message may include the ID of the wireless tracking device and an ID of the wireless communication device. The reporting message may be transmitted at block 710 to an emergency location server 150 using a wireless communication protocol. In some embodiments, the wireless communication protocol for transmitting the reporting message at block 710 is a long range and/or cellular communication protocol. The reporting message may be transmitted at block 710 to an emergency location server automatically without the wireless communication device user's input and/or without notifying the wireless communication device user.

After transmitting a reporting message, a wireless communication device may determine if a location command has been received from the emergency location server at block 715. In some embodiments, a wireless communication device may wait to transmit any information relating to at least one location of the wireless communication device until a location command received from the emergency location server. If no location command is received, then the wireless communication device may disconnect from the emergency location server after a predetermined period of time and/or may receive a disconnect command from the emergency location server.

In other embodiments, a wireless communication device may automatically transmit information relating to at least one location of the wireless communication device to the emergency location server. Thus, the receipt of a location command at block 715 may be optional in some embodiments. If a location command is not required, then the wireless communication device may automatically proceed to block 720 without waiting at block 715. Stated in other words, decision block 715 may be omitted.

In some embodiments, an override of the global and/or terrestrial positioning system and/or non-cellular communication system in a wireless communication device may occur. Overriding a positioning system and/or non-cellular communication system refers to enabling the positioning system and/or non-cellular communication system regardless of user settings. An override of the positioning system and/or non-cellular communication system may occur by the positioning system and/or non-cellular communication system remaining enabled without the user's knowledge after attempts to disable the positioning system and/or non-cellular communication system. For example, a user may turn off or disable a positioning system, such as, a GPS, but in response to receiving a distress message and/or a message from the emergency location server, such as, but not limited to a location command, the GPS of the wireless communication device may be enabled. The settings for the wireless communication device (e.g., an icon) may still show or indicate that the GPS is off pursuant to the user's selection, but the GPS may be on for the purposes of the present disclosure (e.g., to transmit a reporting message and/or information relating to at least one location of the wireless communication device). The override may thus not alter the visible indications for settings selected by the user for the positioning system and/or non-cellular communication system. Thus, the user may not be aware and/or the wireless communication device may not indicate that the GPS is on or enabled. This may allow for the reporting message and/or information relating to at least one location of the wireless communication device to be transmitted without user input and/or without user notification.

In some embodiments, enabling block/operation 720 may be omitted. In certain embodiments, the enabling operation may be omitted since the positioning system and/or cellular communication system may already be enabled.

Information relating a location of the wireless communication device may be sent to the emergency location server at block 730. Location information relating to the wireless communication device may be sent to the emergency location server until a disconnect command is received by the wireless communication device at block 740. The disconnect command may be sent or initiated by someone associated with the emergency location server. In some embodiments, where block 715 is omitted, the emergency location server may be configured to transmit a disconnect command after a predetermined period of time passing, such as, for example, a predetermined period of time passing without receiving an emergency command.

Responsive to receiving the disconnect command, the wireless communication device may disconnect communication to the emergency location server at block 750. The global and/or terrestrial positioning system and/or non-cellular communication system may be disabled and/or returned to the user's selected setting(s) at block 755.

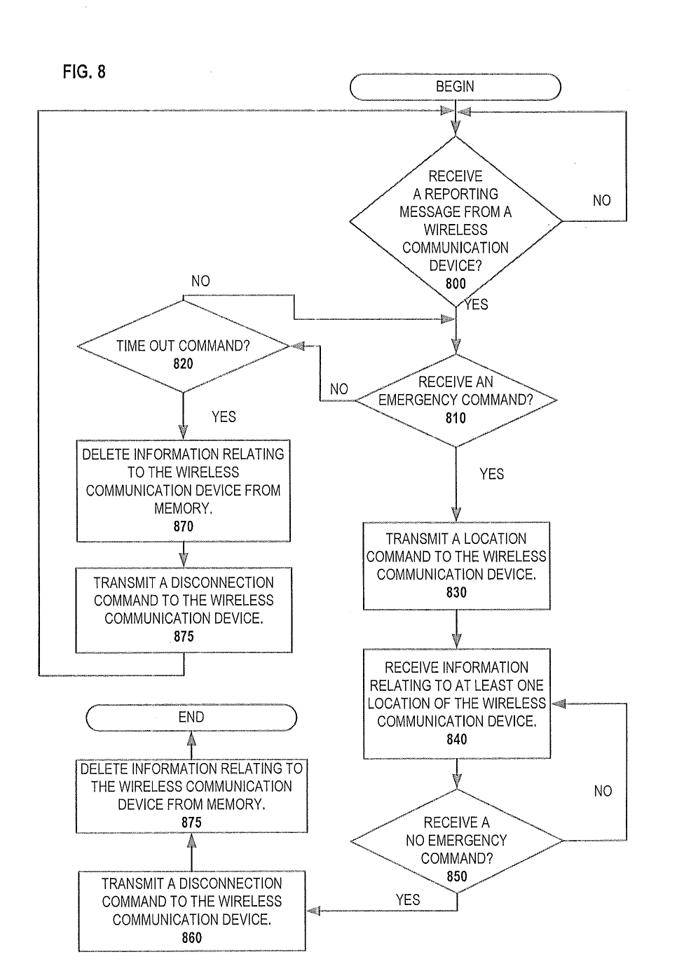

FIG. 8 illustrates a flowchart for an emergency location server 150 according to some embodiments. An emergency location server 150 may determine if a reporting message has been received from a wireless communication device at block 800. The reporting message may include an ID for both a tracking device and a wireless communication device. If no reporting message has been received, then the emergency location server may wait for a reporting message.

However, if the emergency location server does determine that a reporting message has been received, then the emergency location server may determine if an emergency command has been received at block 810. An emergency command may be sent by a user (i.e., an individual utilizing the tracking device), someone associated with a user, and/or an agent (e.g., a government agent such as a police officer). In some embodiments, an emergency location command may be needed to enable and/or initiate the transmission of information from the wireless communication device 120 relating a location of the wireless communication device. The emergency location command may provide confirmation that the distress message was accurate and not a false alarm.

If no emergency command has been received at block 810, then the emergency location server may determine if a time out command has been received at block 820. A time out command may be sent after a predetermined period of time, such as, but not limited to, about 24 hours, 36 hours, 72 hours, 96 hours etc. The time out command may provide for time to determine if the distress message upon which the reporting message was sent was in error (e.g., a false alarm) or an actual emergency. The time out command may be automatically generated by the emergency location server and/or monitoring device after a predetermined period of time. In some embodiments, the time out command may be responsive to a predetermined period of time passing after receiving a reporting message without receiving an emergency command relating to the tracking device for which the reporting message was sent. The amount of time may be the same and/or different for different tracking devices and/or users.

In some embodiments, the emergency location server may wait until an emergency command is received before transmitting a location command to the one or more wireless communication devices. However, if a time out command is generated before any emergency commands, then the emergency location server may delete the information relating to the wireless communication device from memory at block 870 and/or may transmit a disconnection command to the wireless communication device at block 875.

In some embodiments, an emergency command may be received before a time out command at block 810, and in response, a location command may be sent to the wireless communication device at block 830. The location command may initiate the transmission of information from at least one wireless communication device relating to a location of the wireless communication device and/or may enable a positioning system and/or non-cellular communication system of the at least one wireless communication device. The emergency location server may then receive information relating to at least one location of the wireless communication device at block 840. Location information associated with the at least one wireless communication device may be transmitted to the emergency location server in real-time and/or at predetermined time intervals.

The location information associated with the at least one wireless communication device may be transmitted to the emergency location server until the emergency location server receives a no emergency command. Thus, the emergency location server may continuously or at predetermined time intervals determine if a no emergency command has been received at block 850. A no emergency command may be sent to the emergency location server by a user, someone associated with a user, the monitoring device, and/or an agent (e.g., police officer). The no emergency command may indicate that there is no longer a need for location information from at least one wireless communication device and/or for a tracking device. Thus, in some embodiments, a no emergency command may be specific to a particular wireless communication device or may be in regard to a particular tracking device and all wireless communication devices associated with the tracking device at the time of the no emergency command (i.e., the wireless communication devices that received the distress message from the same tracking device and transmitted a reporting message and/or may be transmitting location information to the emergency location server).

If a no emergency command is not received by the emergency location server, then location information may continue to be sent from the at least one wireless communication device to the emergency location server.

Responsive to receiving a no emergency command at block 850, the emergency location server may transmit a disconnection command to the at least one wireless communication device at block 860. The disconnection command may terminate the transmissions from the wireless communication device to the emergency location server and/or may reset the settings of the wireless communication device prior to receiving the reporting message and/or location command. For example, in some embodiments, the positioning system and/or non-cellular communication settings may be returned to the user's settings prior to receipt of the distress message. This may be accomplished without the input and/or knowledge of the wireless communication device user.

Further, in response to receiving a no emergency command, the emergency location server may delete the information relating to the wireless communication device from memory at block 875. This may include the wireless communication device ID and/or location information associated with the wireless communication device.

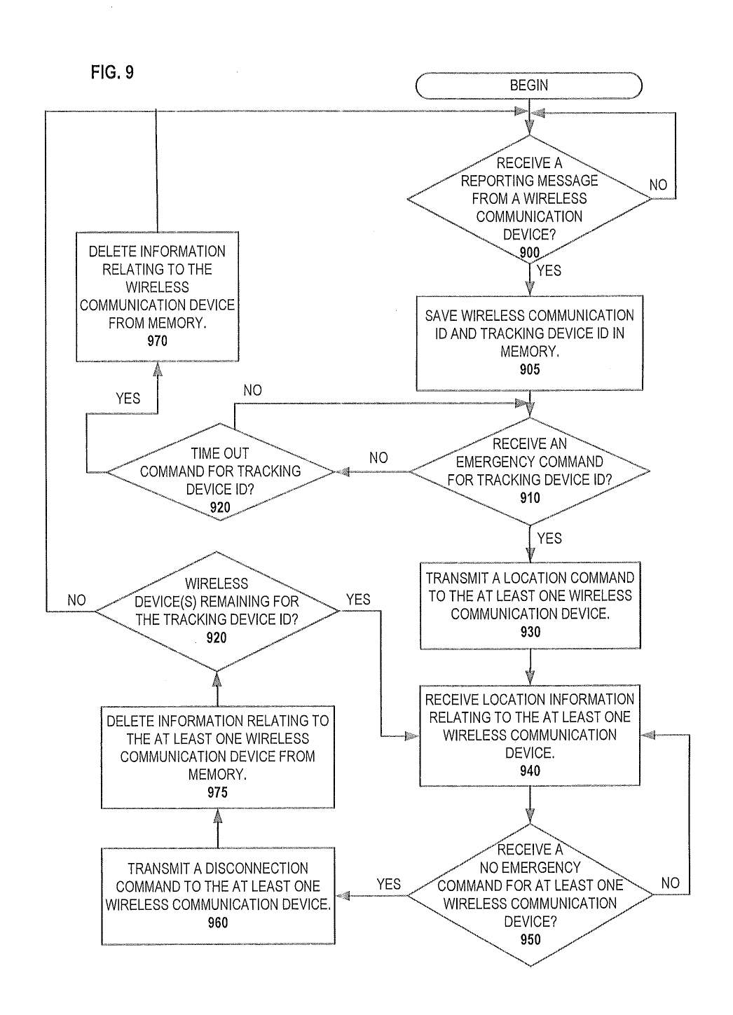

FIG. 9 illustrates a flowchart for an emergency location server 150 according to some embodiments. An emergency location server 150 may receive information associated with more than one tracking device that may be associated with different users. However, in either embodiment, the emergency location server 150 may still receive transmissions from more than one wireless communication device 120 since the tracking device may send the distress message to any wireless communication device within range to receive the distress message. Thus, the emergency location server may need to identify transmissions and/or communications in regard to a specific wireless communication device associated with a particular tracking device in plurality and, in some embodiments, for more than one tracking device. Accordingly, the emergency location server may determine if a reporting message has been received from at least one wireless communication device 900. The emergency location server may not store any information in memory if a reporting message has not been received.

Responsive to receiving a reporting message, the emergency location server may save the wireless communication device ID(s) and the tracking device ID(s) in memory at block 905. If the emergency location server is receiving transmissions associated with multiple tracking devices, then the wireless communication device IDs may be saved in memory in a manner that associates the wireless communication device with the particular tracking device, such as, for example, as shown in Table 1.

TABLE 1

| Tracking Device ID #1 | Tracking Device ID #2 | Tracking Device ID #3 |
|---|---|---|
| Wireless communication | Wireless | Wireless |
| device ID #1 | communication | communication |
| | device ID #5 | device ID #7 |
| Wireless communication | Wireless | Wireless |
| device ID #2 | communication | communication |
| | device ID #6 | device ID #8 |
| Wireless communication | | Wireless |
| device ID #3 | | communication |
| | | device ID #9 |
| Wireless communication | | |
| device ID #4 | | |

In some embodiments, a location command may automatically be sent to the one or more wireless communication devices at block 930. Thus, receiving an emergency command at block 910 may be optional. In some embodiments, transmission/reception of location information from the one or more wireless communication devices may continue until a time out command for a particular tracking ID is received. That is, if the distress message has not been verified and/or an emergency command has not been received at block 910 (e.g., when block 910 is omitted), then the emergency location server may receive a time out command at block 920 and/or may send a disconnection command at block 960 to the one or more wireless communication device(s). The information relating to the one or more wireless communication device(s) may then be deleted from memory of the emergency location server at block 975 and/or block 970.

Alternatively or in addition, the emergency location server may first determine if an emergency command has been received for a particular tracking device ID at block 910. In some embodiments, the option of waiting for an emergency command before transmitting a location command may be based on tracking device user settings and/or a government requirement or order.

According to some embodiments, if a no emergency command is received for a particular tracking device ID, then the emergency location server may determine if a time out command has been received for that particular tracking device ID at block 920. If no time out command has been received for the tracking device ID, then the tracking device ID and any wireless communication device IDs may continue to be stored in the memory of the emergency location server. If a time out command has been received, then the emergency location server may delete information relating to the wireless communication device from memory at block 970. This may include part or all of the information associated with the wireless communication device, such as, the ID of the wireless communication device.

If an emergency command has been received for a particular tracking device ID, then, in some embodiments, a location command may be sent to the one or more wireless communication device(s) associated with the tracking device ID at block 930. The emergency location server may then receive information related to the location of the one or more wireless communication device(s) at block 940. The emergency location server may store the location information in memory in a manner so that the location information is associated with the particular wireless communication device as well as the tracking device associated with the wireless communication device. Thus, for each wireless communication device associated with a particular tracking device, location information may be separately received and stored so as to identify not only the wireless communication device for which the location information corresponds to but also the tracking device associated with the wireless communication device.

In certain embodiments, a location command may only be sent to one wireless communication device or a subset of wireless communication devices associated with a particular tracking device. Thus, a location command may be selectively sent to a particular wireless communication device associated with a tracking device ID. The selective transmission of a location command may be in response to a government request for location information for a particular wireless communication device associated with a tracking device ID (e.g., the subject associated with the wireless communication device is of interest or a suspect) and/or may be in response to a request for location information from a user and/or someone associated with a user of the tracking device.

Location information may be received in regard to a particular wireless communication device until a no emergency command is received for at least one wireless communication device. The emergency location server may thus determine if a no emergency command has been received in regard to at least one wireless communication device at block 950. In some embodiments, the no emergency command may be received for all wireless communication devices associated with a particular tracking device ID.

If a no emergency command has been received, then the emergency location server may transmit a disconnection command to the at least one wireless communication device at block 960. The emergency location server may also delete information relating to the least one wireless communication device from memory at block 975.

The emergency location server may then determine if one or more wireless communication devices remain for the particular tracking device ID at block 920. If so, then the emergency location server may continue to receive information relating to the remaining wireless communication device(s). The emergency location server may continue to receive location information until a no emergency command is received.

If no wireless communication devices remain for a particular tracing device ID, then the emergency location server may delete information relating to the tracking device ID. The emergency location server may then again determine if a reporting message has been received from a wireless communication device. If the emergency location server receives transmissions associated with more than one tracking device ID, then one or more different or the same steps may be occurring at any given time.

Some embodiments of the inventive subject matter may be implemented using wireless communications standards (also referred to as protocols), such as that defined by the 3GPP Specification, which covers GSM (including GPRS and EDGE), W-CDMA and LTE (including LTE-Advanced) specifications (the 3GPP specification is available at www.3GPP.org). For example, some embodiments may be specified by changes and/or additions to physical layer aspects defined at 3GPP TS 36.211, 36.212 and/or 36.213 and/or radio resource control aspects defined at 3GPP TS 36.331. It will be appreciated that these sections are cited as examples, and that embodiments of the inventive subject matter may be implemented in 3GPP or other communications specifications in a number of different ways.

Embodiments of the inventive subject matter may allow for and/or extend the capability to locate an object being tracked with a tracking device 110. For example, if a user with a tracking device 110 is kidnapped and the kidnapper improperly removes the tracking device 110, then the tracking device 110 can transmit a distress message automatically without user input using a wireless communication protocol, such as, for example, Wifi and/or Bluetooth. Any wireless communication device 120 in range, such as, e.g., the kidnapper's mobile telephone, may receive the distress message. If the kidnapper's mobile telephone receives the distress message, then, in response, the kidnapper's mobile telephone can transmit a reporting message to the emergency location sever 150 automatically without the kidnapper's input and/or without notifying the kidnapper. The reporting message can include an ID for both the tracking device and the kidnapper's mobile telephone, which the emergency location server 150 can save. If the police are notified that the user is missing, then the police can access the emergency location server 150 and request location information be transmitted from the kidnapper's mobile telephone to the emergency location server 150. The police can then access the location information from the emergency location server 150 and track the kidnapper based on the location information provided to the emergency location server by the kidnapper's mobile telephone. Embodiments of the inventive subject matter may also aid the police in identifying suspects and/or witnesses since the suspects and/or witnesses may have been in the area when the tracking device 110 was improperly removed and may have had a wireless communication device 120 that received the distress message and transmitted a reporting message to the emergency location server 150.

Many variations and modifications can be made to the embodiments disclosed herein without substantially departing from the principles of the inventive subject matter. All such variations and modifications are intended to be included herein within the scope of the inventive subject matter, as set forth in the following claims.

That which is claimed:

1. A method of operating a wireless tracking device, the method comprising:
determining information relating to a location of the wireless tracking device;
transmitting the information relating to the location of the wireless tracking device to a monitoring device using a first wireless communication protocol; and
responsive to detecting an activation event, transmitting a distress message to at least one wireless communication device using a second wireless communication protocol different than the first wireless communication protocol, wherein the distress message comprises an identification of the wireless tracking device.

2. The method of claim 1, wherein the first communication protocol is a long range communication protocol and the second communication protocol is a short range communication protocol.

3. The method of claim 1, wherein the first communication protocol is a cellular communication protocol and the second communication protocol is a non-cellular communication protocol.

4. The method of claim 3, wherein the second communication protocol includes at least one of WiFi, Bluetooth, WiMax, ZigBee, near field communication (NFC), infrared, and/or Ultra Wide Band (UWB).

5. The method of claim 1, wherein the monitoring device comprises a monitoring server.

6. The method of claim 1, wherein determining information relating to the location of the tracking device comprises determining the information responsive to Global Positioning System (GPS) signals received from at least one global positioning satellite and/or using positioning signals received from a terrestrial positioning system.

7. The method of claim 1, wherein transmitting the distress message comprises transmitting the distress message automatically in response to the activation event without user input.

8. The method of claim 1, wherein the activation event comprises improper removal of the tracking device and/or, responsive to user entry of a distress code, the activation event comprises receiving the distress code.

9. A method of operating a wireless communication device, the method comprising:
receiving a distress message from a wireless tracking device, wherein the distress message includes an identification of the wireless tracking device; and
responsive to receiving the distress message, transmitting a reporting message to an emergency location server, wherein the reporting message includes the identification of the wireless tracking device and an identification of the wireless communication device.

10. The method of claim 9, further comprising transmitting information relating to a location of the wireless communication device to the emergency location server.

11. The method of claim 10, wherein transmitting the information relating to the location of the wireless communication device comprises transmitting the information responsive to receiving a location command from the emergency location server.

12. The method of claim 9, wherein receiving the distress message comprises receiving the distress message using a short range wireless communication protocol, and wherein transmitting the reporting message comprises transmitting the reporting message using a long range wireless communication protocol.

13. The method of claim 9, wherein receiving the distress message comprises receiving the distress message using a non-cellular communication protocol, and wherein transmitting the reporting message comprises transmitting the reporting message using a cellular communication protocol.

14. The method of claim 13, wherein the non-cellular communication protocol is at least one of WiFi, Bluetooth, WiMax, ZigBee, near field communication (NFC), infrared, and Ultra Wide Band (UWB).

15. The method of claim 9, wherein transmitting the reporting message comprises transmitting the reporting message automatically in response to the distress message without user input.

16. The method of claim 9, further comprising overriding a global and/or terrestrial positioning system and/or a non-cellular communication system without user input and/or without user notification.

17. A method of operating an emergency location server, the method comprising:
receiving a first reporting message from a first wireless communication device, the reporting message including an identification of the first wireless communication device and an identification of a first tracking device.

18. The method of claim 17, further comprising:
receiving a second reporting message from a second wireless communication device, the second reporting message including an identification of the second wireless communication device and an identification of a second tracking device; and
responsive to a predetermined period of time passing after receiving the second reporting message without receiving an emergency command relating to the second tracking device, removing the information relating to the second tracking device from memory at the emergency location server.

19. The method of claim 17, further comprising, responsive to an emergency command relating to the first tracking device, transmitting a location command to the first wireless communication device; and
receiving information relating to a location of the first wireless communication device.

20. The method of claim 19, further comprising, responsive to a no emergency command relating to the first tracking device, transmitting a disconnection command to the first wireless communication device; and
removing the information relating to the first wireless communication device from memory at the emergency location server.
